(19) United States
(12) Patent Application Publication
(10) Pub. No.: US 2011/0163713 A1
(43) Pub. Date: Jul. 7, 2011

(54) Wireless charging system and charging method thereof

(75) Inventors: Yu-Chi WANG, Sanchung (TW); Ruey-Cheng MAU, Sanchung (TW)

(73) Assignee: KYE SYSTEMS CORP., Taipei Hsien (TW)

(21) Appl. No.: 12/662,728

(22) Filed: Apr. 30, 2010

(30) Foreign Application Priority Data
Jan. 6, 2010 (TW) 099100154

(51) Int. Cl. H02J 7/00

(52) U.S. Cl. 320/108

(57) ABSTRACT

A wireless charging system and charging method thereof allows a wireless charging stand to wireless charge an electronic device through electromagnetic induction. The wireless charging stand periodically activates to determine if the electronic device enters a predetermined range. Once the electronic device is sufficiently close, a transmission coil of the wireless charging stand transmits electromagnetic waves induced by a reception coil of the electronic device to generate current. The current is intermittently connected to a load by activating and deactivating a switch based on a charge time sequence to correspondingly change current consumption of the transmission coil. The wireless charging stand determines if the time sequence associated with current consumption is identical to a charge identification time sequence. The transmission coil continues charging if positive, and stops charging if negative, thereby preventing a wireless charging stand and electronic device having different voltage specification from being damaged to ensure operational safety.

### BACKGROUND OF THE INVENTION

1. Field of the Invention

The present invention is related to a wireless charging system and charging method thereof, and more particularly to a wireless charging system and charging method thereof having an identification scheme and effectively filtering use of a wireless charging stand and an electronic device having incompatible voltage specifications to ensure operational safety.

2. Description of the Related Art

Although inductive charging of electronic devices, such as toothbrushes and computer mice, is increasingly popular, management and safety issues remain a concern, principally due to different products manufactured by different vendors having different voltage specifications. When a wireless charging stand works is used with a non-compatible electronic device, an attempt to charge the electronic device is initiated because the wireless charging stand does not attempt to recognize if the electronic device is compatible. Therefore, the device may be damaged or hazardous circuit thus formed risks fire or electrocution.

With reference to FIG. 5, a conventional wireless charging system (90) connected to a personal computer has a receiving module (91), an identification module (92) and a charging module (93). The receiving module (91) is equipped with an RFID reader that wirelessly receives an identification code from a device equipped with an RFID tag when the device enters a pre-determined range. The identification module (92) serves to determine if a received identification code is a preset identification code. The charging module (93) starts wirelessly charging the device if a determination result of the identification module (92) is positive. Once the device leaves the pre-determined range, the charging module (93) stops charging the device.

The RFID approach indeed offers charge management based on operation permission. However, the device needs to have an RFID tag to transmit and receive the identification code, which adds to device cost and manufacturing complexity.

### SUMMARY OF THE INVENTION

A first objective of the present invention is to provide a wireless charging system, using a wireless charging stand to identify an electronic device before charging it without adding any specific element.

To achieve the foregoing objective, the wireless charging system has a wireless charging stand and an electronic device.

The wireless charging stand has a transmission coil, a current detector, a transmission circuit, and a transmission processor. The transmission circuit has an output terminal connected with the transmission coil to drive the transmission coil to transmit an electromagnetic wave. The transmission processor has an input terminal, an output terminal, a charge identification time sequence, a saturated identification time sequence and a load detection process. The input terminal is connected with the transmission coil through the current detector for detecting a current consumption condition of the transmission coil. The output terminal is connected with the input terminal of the transmission circuit for controlling the transmission circuit. The load detection process is executed by the transmission processor to determine the current consumption condition of the transmission coil with the charge identification time sequence and the saturated identification time sequence.

The electronic device has a load and a power supply module. The power supply module has a reception coil, a rectifier, a rechargeable battery, a switch, a charger and a reception processor. The reception coil generates a current induced from the electromagnetic wave. The switch is connected between an output terminal of the rectifier and the load. The charger is connected with the rechargeable battery to charge the rechargeable battery with the current generated by the reception coil and connected with the reception coil through the rectifier. The reception processor has a charge time sequence, a saturated time sequence and an activation scheduling process. The activation scheduling process is executed by the reception processor to activate or deactivate the switch according to the charge time sequence or a saturated time sequence before or after the rechargeable battery has a saturated power storage.

A second objective of the present invention is to provide a charging method, using a wireless charging stand to identify an electronic device before charging it without adding any specific element. The charging method has steps of:

providing a wireless charging stand to transmit an electromagnetic wave;

providing an electronic device to sense the electromagnetic wave and generate a load varying with a charge time sequence;

determining if a time sequence with which a current consumption signal varies of the wireless charging stand is the same as a charge identification time sequence; and

enabling the wireless charging stand to charge a rechargeable battery of the electronic device if positive.

When the electronic device is placed near or approaches the wireless charging stand, a current is induced in the reception coil of the electronic device by the electromagnetic wave transmitted from the wireless charging stand. The reception processor activates and deactivates the switch connected with the load based on the charge time sequence. When the load varies with the charge time sequence, the current consumption of the transmission coil also varies with a time sequence. The transmission processor determines if the time sequence associated with the current consumption of the transmission coil is the same as the built-in charge identification time sequence. If positive, the electronic device to be charged is treated as a “legal device”, and the reception processor constantly drives the transmission circuit to continue charging the electronic device. Otherwise, if the transmission coil does not vary with any time sequence at all or a time sequence with which the transmission coil varies differs from the charge identification time sequence, the electronic device is treated as an “illegal device”, and the transmission processor shuts down the transmission circuit without charging the electronic device. Using the aforementioned device can effectively manage operation permission and ensure operational safety. As no additional identification devices are used, there is no significant production cost or complexity.

### BRIEF DESCRIPTION OF THE DRAWINGS

FIG. 1 is a functional block diagram of a wireless charging system having a wireless charging stand and an electronic device in accordance with the present invention;

FIG. 2 is a flow diagram of a charging method of the wireless charging stand;

FIG. 3 is a flow diagram of the electronic device when the electronic device operates normally;

FIG. 4 is a flow diagram of a charging method of the electronic device; and

FIG. 5 is a block diagram of a conventional wireless charging system.

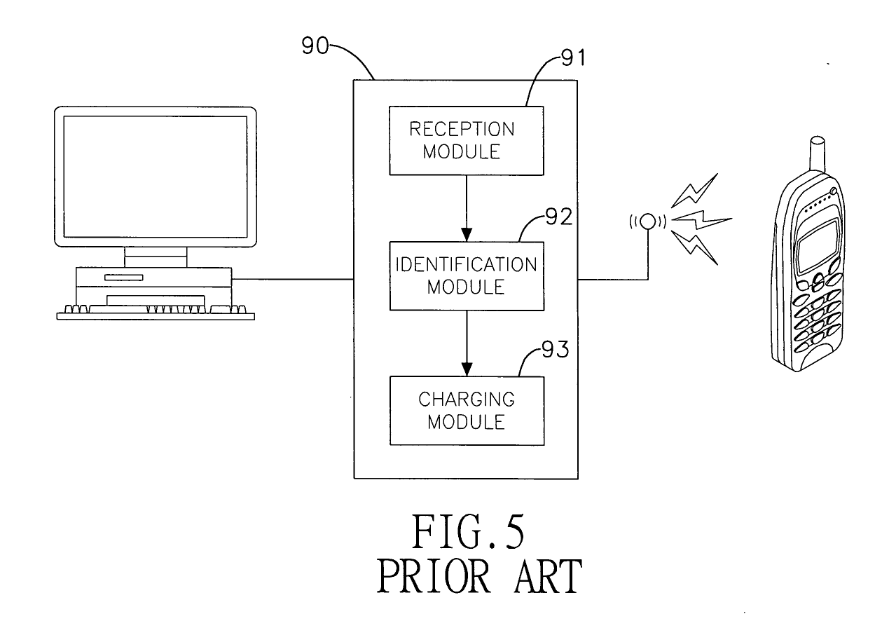

### DETAILED DESCRIPTION OF THE INVENTION

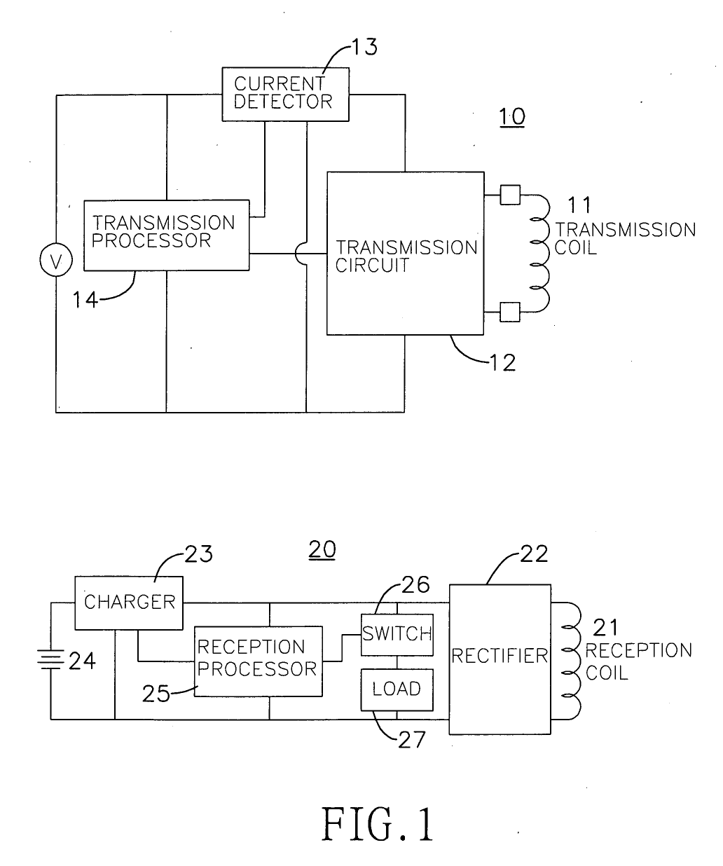

With reference to FIG. 1, a wireless charging system in accordance with the present invention has a wireless charging stand (10) and a compatible electronic device (20).

The wireless charging stand (10) has a transmission coil (11), a transmission circuit (12), a current detector (13) and a transmission processor (14). The transmission coil (11) serves as an induction coil for transmitting electromagnetic waves. The transmission circuit (12) has an input terminal and an output terminal. The output terminal of the transmission circuit (12) is connected with the transmission coil (11) to transmit modulated signals through the transmission coil (11). The transmission circuit (12) may be a pulse width modulation controller. The current detector (13) has an input terminal and an output terminal. The input terminal of the current detector (13) is connected with the input terminal of the transmission circuit (12) to detect a current condition of the transmission coil (11). The transmission processor (14) is composed of a micro-controller unit (MCU) and has an input terminal, an output terminal, a load detection process, a charge identification time sequence and a saturated identification time sequence. The input terminal of the transmission processor (14) is connected with the output terminal of the current detector (13) to detect a current consumption signal of the transmission coil (11). The output terminal of the transmission processor (14) is connected with the input terminal of the transmission circuit (12). The transmission processor (14) executes the load detection process to determine if a time sequence with which the current consumption signal varies is the same as in the charge identification time sequence when the wireless charging stand (10) is compatible with the electronic device (20) or the same as the saturated identification time sequence when the electronic device (20) has a saturated power.

The electronic device (20) may be a consumer electronic product, such as, but not limited to a computer peripheral, mobile phone or toothbrush, has a power supply module and a load (27), and is charged and supplied power through a power supply module. The power supply module has a reception coil (21), a rectifier (22), a charger (23), a rechargeable battery (24), a reception processor (25) and a switch (26). The reception coil (21) serves as an induction coil for generating current induced from electromagnetic waves transmitted from the wireless charging stand (10). The rectifier (22) has an input terminal and an output terminal. The input terminal of the rectifier (22) is connected with the reception coil (21) to rectify the induction current to DC current. The charger (23) has an input terminal and an output terminal. The input terminal of the charger (23) is connected with the output terminal of the rectifier (22) to acquire the rectified DC current. The rechargeable battery (24) is connected with the output terminal of the charger (23) and is charged by the charger (23). The rechargeable battery (24) supplies power to operate the electronic device (20) and each component in the electronic device (20). The reception processor (25) is composed of an MCU and has an input terminal and an output terminal, an activation scheduling process, a charge time sequence and a saturated time sequence. The input terminal of the reception processor (25) is connected with the rechargeable battery (24) to determine a power condition of the rechargeable battery (24). The switch (26) is connected between the output terminal of the rectifier (22) and the load (27) of the electronic device (20). The reception processor (25) executes the activation scheduling process to activate and deactivate the switch (26) according to the charge time sequence and the saturated time sequence before and after detecting the saturated power storage of the rechargeable battery (24).

As the wireless charging stand (10) and the electronic device (20) are compatible in operation, the charge identification time sequence and the saturated identification time sequence built in the transmission processor (14) should correspond to the charge time sequence and the saturated time sequence built in the reception processor (25).

The detailed description about operation of the wireless charging stand (10) and the electronic device (20) is as follows:

The wireless charging stand (10) periodically activates the transmission circuit (12) to enable the transmission coil (11) to radiate electromagnetic wave, and determines if there is a load existing in the electronic device (20). If positive, the wireless charging stand (10) executes the load detection process and starts charging the electronic device after the load detection process verifies that the wireless charging stand (10) and the electronic device are compatible. If there is no load existing in the electronic device (20), the wireless charging stand enters a stand-by mode after transmitting electromagnetic waves for a short while.

When an electronic device is placed on or approaches the wireless charging stand (10), the transmission processor (14) of the wireless charging stand (10) drives the transmission circuit (12) to transmit electromagnetic waves so that the electronic device (20) generates current induced from the electromagnetic waves transmitted from the transmission coil (11). The reception processor (25) then executes the activation scheduling process to activate and deactivate the switch (26) according to the charge time sequence so that the reception coil (21) is also alternately activated and deactivated based on the charge time sequence. When the electronic device (20) activates and deactivates the reception coil (21) according to the charge time sequence, the current consumption of the transmission coil (11) varies according to a time sequence. The current consumption of the transmission coil (11) varying according to the time sequence is detected by the transmission processor (14) through the current detector (13). The transmission processor (14) executes the load detection process to determine if the time sequence with which the current consumption of the transmission coil (11) varies is identical to the charge identification time sequence. If positive, it indicates that the electronic device (20) to be charged is a “legal device”. The transmission processor (14) continues driving the transmission circuit (12) to supply power to the electronic device (20).

If the transmit processor (14) determines that the transmission coil (11) does not vary according to any time sequence at all or varies according to a time sequence different from the charge identification time sequence, it indicates that the electronic device to be charged is an “illegal device”, the transmission processor (14) then shuts down the transmission circuit (12) and stops charging the electronic device.

Before performing the activation scheduling process to activate and deactivate the switch (26), the reception processor (25) first determines if the power capacity of the rechargeable battery (24) is saturated. If positive, there are two modes corresponding to the condition when the power capacity of the rechargeable battery (24) is saturated during a charging process.

1. The reception processor (25) activates and deactivate the switch (26) according to the saturated time sequence when the rechargeable battery (24) has a saturated power storage. The transmission processor (14) executes the load detection process to detect if the current consumption of the transmission coil (11) varies with the saturated identification time sequence, and if positive, actively stops sending electromagnetic waves. If the wireless charging stand (10) intends to periodically detect the variation of the load again, the aforementioned load detection process for verifying consistency of time sequences must be performed again.

2. When the wireless charging stand (10) performs charging, the charging action is periodic (for example, powering off for a time period, such as every 5 minutes). When each break takes place, the reception processor (25) must repeatedly determine if the power of the rechargeable battery (24) is saturated again. If positive, the reception processor (25) will not perform the activation scheduling process or the electronic device (20) generates no current induced from the electromagnetic wave transmitted from the wireless charging stand (10) at all. As the wireless charging stand (10) fails to determine the current consumption variation of the transmission coil (11), no charging action is performed. Hence, even if the electronic device (20) is located within an electromagnetic induction range of the wireless charging stand (10), the wireless charging stand (10) will not perform charging to avoid unnecessary waste of power if the rechargeable battery (24) is saturated.

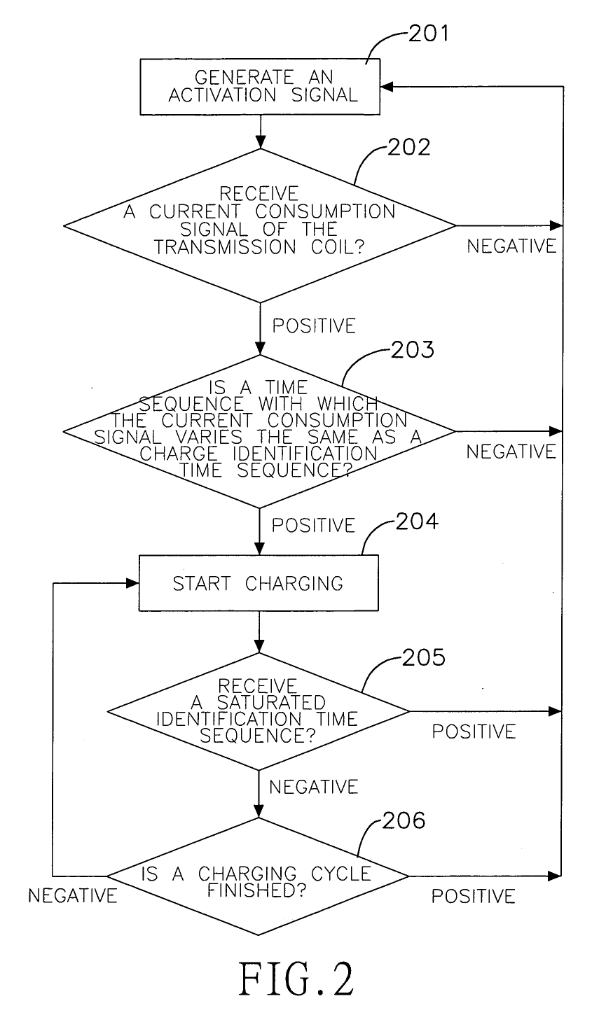

Based on the above-mentioned description, with reference to FIG. 2, a charging method performed by the wireless charging stand has steps of:

generating an activation signal (201); it is the transmission coil transmitting electromagnetic wave;

determining if receiving a current consumption signal of the transmission coil (202); if positive, performing next step; otherwise, returning to step (201);

determining if a time sequence with which the current consumption signal varies is the same as the charge identification time sequence (203); if positive, performing next step; otherwise, returning to step (201);

starting charging (204);

determining if receiving a saturated identification time sequence (205); if positive, stop charging and returning to step (201); otherwise, performing next step; and

determining if a charging cycle is finished (206) (the wireless charging stand (10) periodically performs charging and the charging cycle has a time period, for example, 5 minutes.); if positive, returning to step (201) to determine the time sequence with which the current consumption varies and the saturated identification time sequence again; otherwise, returning to step (204) to resume charging;

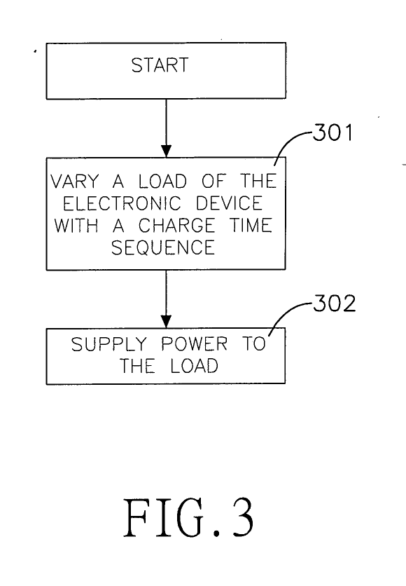

With reference to FIG. 3, normal operation of the power supply module of the electronic device has the following steps:

varying a load of the electronic device with the charge time sequence (301); and

supplying power to the load (302).

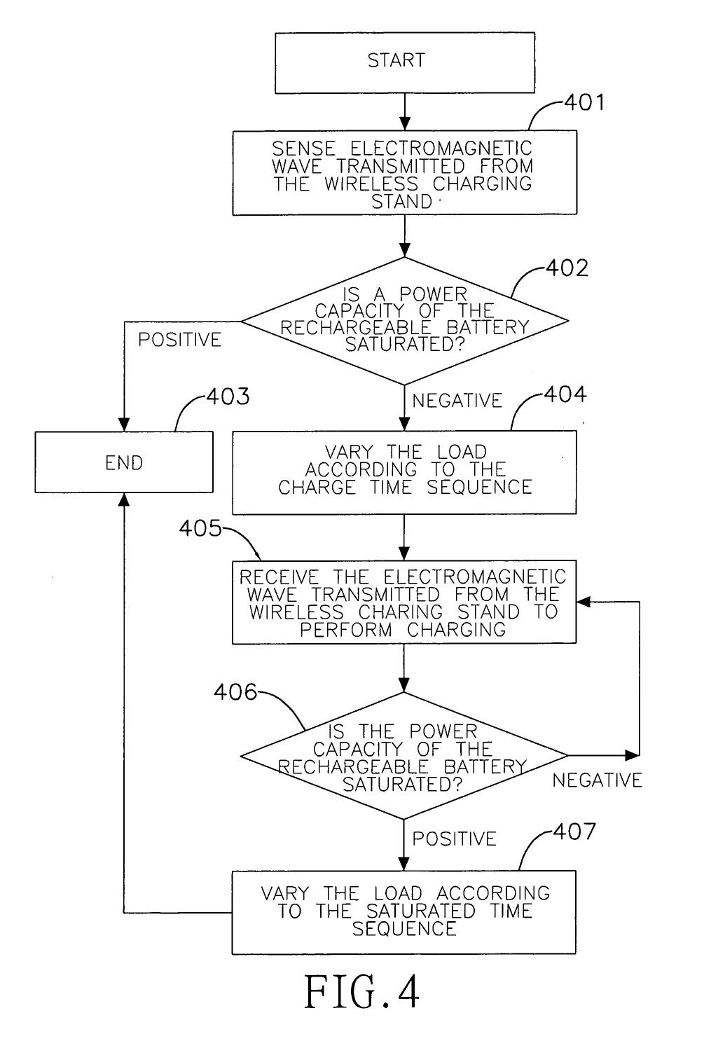

With reference to FIG. 4, a charging method of the power supply module of the electronic device has steps of:

sensing electromagnetic wave transmitted from the wireless charging stand (401);

determining if a power capacity of the rechargeable battery is saturated (402);

if positive, terminating (403);

if negative, varying the load according to the charge time sequence (404);

receiving the electromagnetic wave transmitted from the wireless charging stand to perform charging (405);

determining again if the power capacity of the rechargeable battery is saturated (406); and

if negative, resuming charging (405); otherwise, varying the load according to a saturated time sequence (407).

When the transmission processor (14) executes the load detection process to detect the saturated identification time sequence, the wireless charging stand (10) stops transmitting electromagnetic wave, and the electronic device (20) also stop varying the load according to the charge time sequence.

Even though numerous characteristics and advantages of the present invention have been set forth in the foregoing description, together with details of the structure and function of the invention, the disclosure is illustrative only. Changes may be made in detail, especially in matters of shape, size, and arrangement of parts within the principles of the invention to the full extent indicated by the broad general meaning of the terms in which the appended claims are expressed.

What is claimed is:

1. A wireless charging system, comprising:
a wireless charging stand having:
a transmission coil;
a current detector;
a transmission circuit having an output terminal connected with the transmission coil to drive the transmission coil to transmit an electromagnetic wave; and
a transmission processor having:
an input terminal connected with the transmission coil through the current detector for detecting a current consumption condition of the transmission coil;
an output terminal connected with the input terminal of the transmission circuit for controlling the transmission circuit;
a charge identification time sequence;
a saturated identification time sequence; and
a load detection process executed by the transmission processor to determine the current consumption condition of the transmission coil with the charge identification time sequence and the saturated identification time sequence; and
an electronic device having:
a load; and
a power supply module having:
a reception coil generating a current induced from the electromagnetic wave;
a rectifier;
a rechargeable battery;
a switch connected between an output terminal of the rectifier and the load;
a charger connected with the rechargeable battery to charge the rechargeable battery with the current generated by the reception coil and connected with the reception coil through the rectifier; and
a reception processor having:
a charge time sequence;
a saturated time sequence;
an activation scheduling process executed by the reception processor to activate or deactivate the switch according to the charge time sequence or a saturated time sequence before or after the rechargeable battery has a saturated power storage.

2. The wireless charging system as claimed in claim 1, wherein the transmission circuit of the wireless charging stand is a pulse width modulation controller.

3. The wireless charging system as claimed in claim 1, wherein each of the transmission processor and the reception processor is composed of a micro-controller unit (MCU).

4. A charging method performed by the wireless charging stand as claimed in claim 1, comprising steps of:
generating an activation signal;
receiving a current consumption signal of the transmission coil;
determining if a time sequence with which the current consumption signal varies is the same as the charge identification time sequence; and
starting charging if positive and stopping charging if negative.

5. A charging method performed by the wireless charging stand as claimed in claim 2, comprising steps of:
generating an activation signal;
receiving a current consumption signal of the transmission coil;
determining if a time sequence with which the current consumption signal varies is the same as the charge identification time sequence; and
starting charging if positive and stopping charging if negative.

6. A charging method performed by the wireless charging stand as claimed in claim 3, comprising steps of:
generating an activation signal;
receiving a current consumption signal of the transmission coil;
determining if a time sequence with which the current consumption signal varies is the same as the charge identification time sequence; and
starting charging if positive and stopping charging if negative.

7. The charging method as claimed in claim 4, wherein the activation signal is an electromagnetic wave transmitted from the transmission coil.

8. The charging method as claimed in claim 5, wherein the activation signal is an electromagnetic wave transmitted from the transmission coil.

9. The charging method as claimed in claim 6, wherein the activation signal is an electromagnetic wave transmitted from the transmission coil.

10. A charging method employed by the electronic device as claimed in claim 1, comprising steps of:
sensing an electromagnetic wave transmitted from the wireless charging stand;
varying the load with the charge time sequence; and
charging the rechargeable battery with the received electromagnetic wave.

11. A charging method employed by the electronic device as claimed in claim 2, comprising steps of:
sensing an electromagnetic wave transmitted from the wireless charging stand;
varying the load with the charge time sequence; and
charging the rechargeable battery with the received electromagnetic wave.

12. A charging method employed by the electronic device as claimed in claim 3, comprising steps of:
sensing an electromagnetic wave transmitted from the wireless charging stand;
varying the load with the charge time sequence; and
charging the rechargeable battery with the received electromagnetic wave.

13. The charging method as claimed in claim 10, wherein before varying the load with the charge time sequence, the electronic device first executes steps of:
determining if the a power capacity of the rechargeable battery is saturated;
stopping activating or deactivating the switch if positive; and
varying the load with the charge time sequence if negative.

14. The charging method as claimed in claim 11, wherein before varying the load with the charge time sequence, the electronic device first executes steps of:
determining if the a power capacity of the rechargeable battery is saturated;
stopping activating or deactivating the switch if positive; and
varying the load with the charge time sequence if negative.

15. The charging method as claimed in claim 12, wherein before varying the load with the charge time sequence, the electronic device first executes steps of:
determining if the a power capacity of the rechargeable battery is saturated;
stopping activating or deactivating the switch if positive; and
varying the load with the charge time sequence if negative.

16. A charging method, comprising steps of:
providing a wireless charging stand to transmit an electromagnetic wave;
providing an electronic device to sense the electromagnetic wave and generate a load varying with a charge time sequence;
determining if a time sequence with which a current consumption signal varies of the wireless charging stand is the same as a charge identification time sequence; and
enabling the wireless charging stand to charge a rechargeable battery of the electronic device if positive.

17. The charging method as claimed in claim 16, further comprising steps of:
providing the wireless charging stand to periodically transmit the electromagnetic wave and the electronic device to periodically sense the electromagnetic wave;
using the electronic device to detect if a power capacity of the rechargeable battery is saturated;
enabling the electronic device to stop generating the load varying with the charge time sequence and enabling the wireless charging stand to stop charging the electronic device, if positive.

18. The charging method as claimed in claim 17, further comprising steps of:
enabling the electronic device to sense the electromagnetic wave again and generate the load varying with the charge time sequence if the power capacity of the rechargeable battery is not saturated;
enabling the wireless charging stand to determine again if a time sequence with which the current consumption signal varies is the same as the charge identification time sequence; and
enabling the wireless charging stand to charge the rechargeable battery if positive.

19. The charging method as claimed in claim 16, wherein when the power capacity of the rechargeable battery is saturated, the electronic device generates the load varying with a saturated time sequence, the wireless charging stand detects the variation of the load and stops transmitting the electromagnetic wave, and the electronic device stops generating the load varying with the charge time sequence.
